(19) United States
(12) Patent Application Publication
(10) Pub. No.: US 2017/0011419 A1
(43) Pub. Date: Jan. 12, 2017

(54) Life-Cycle Modeling Based on Transaction and Social Media Data

(71) Applicant: International Business Machines Corporation, Armonk, NY (US)

(72) Inventors: Ke Ke Cai, Beijing (CN); Dong Xu Duan, Beijing (CN); Zhong Su, Beijing (CN); Chang Hua Sun, Beijing (CN); Shi Lei Zhang, Beijing (CN); Shi Wan Zhao, Beijing (CN)

(21) Appl. No.: 14/795,134

(22) Filed: Jul. 9, 2015

(51) Int. Cl. G06Q 30/02; G06Q 50/00; G06Q 30/06

(52) U.S. Cl. CPC G06Q 30/0253; G06Q 30/0631; G06Q 50/01

(57) ABSTRACT

A mechanism is provided for personalizing a user's E-commerce environment. Identified lifecycle state transactions associated with the user are modeled by performing a lifecycle state transition probability calculation utilizing collected social media data and transaction data. Utilizing the model of the identified lifecycle state transactions, a two-level Hidden Markov Model (HMM) lifecycle model is generated for current lifecycle states being experienced by the user. Utilizing the two-level HMM lifecycle model for current lifecycle states being experienced by the user, one or more future behavioral predictions are generated with regard to the user's lifecycle. One or more E-commerce recommendations are then issued to the user based on the one or more future behavioral predictions.

### BACKGROUND

The present application relates generally to an improved data processing apparatus and method and more specifically to mechanisms for user life-cycle status modeling based on the user's social media and shopping behavior.

Electronic commerce, commonly known as E-commerce, is the trading of products or services using computer networks, such as the Internet. E-commerce draws on technologies such as mobile commerce, electronic funds transfer, supply chain management, Internet marketing, online transaction processing, electronic data interchange (EDI), inventory management systems, and automated data collection systems. Modem E-commerce typically uses the World Wide Web for at least one part of the transaction's lifecycle, although it may also use other technologies such as

E-commerce is a huge and increasingly growing market, including both Customer-to-Customer (C2C) and Business-to-Customer (B2C). Nowadays, more and more people shop online and attracting customers to an E-commerce site is a great challenge. Personalized service like searches and recommendations is an efficient way to attract customers. However, existing personalized service only considers data in E -commerce sites like transaction history, view, search, favorite, review, and rate.

### SUMMARY

In one illustrative embodiment, a method, in a data processing system, is provided for personalizing a user's E-commerce environment. The illustrative embodiments model identifies lifecycle state transactions associated with the user by performing a lifecycle state transition probability calculation utilizing collected social media data and transaction data. The illustrative embodiments utilize the model of the identified lifecycle state transactions to generate a two-level Hidden Markov Model (HMM) lifecycle model for current lifecycle states being experienced by the user. The illustrative embodiments utilize the two-level HMM lifecycle model for current lifecycle states being experienced by the user to generate one or more future behavioral predictions with regard to the user's lifecycle. The illustrative embodiments then issue one or more E-commerce recommendations to the user based on the one or more future behavioral predictions.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled. to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts one example of a lifecycle modeling mechanism operating within data processing system 300 in accordance with an illustrative embodiment;

FIG. 4 depicts an exemplary two-level Hidden Markov Model (HMM) lifecycle model in accordance with an illustrative embodiment; and

FIG. 5 depicts an exemplary flowchart of the operation performed by a. lifecycle modeling mechanism in personalizing a user's E-commerce environment based on a detection of the user's current state(s) in the user's lifecycle.

### DETAILED DESCRIPTION

The illustrative embodiments provide for user lifecycle status modeling based on user's social media and shopping behavior. The mechanisms of the illustrative embodiments define important life stages and events for a user as well as the sub-lifecycle status. The mechanisms utilize collected training data to construct the lifecycle model, which describes the transmission probability between the user's status, as well as the probability of observation generation. Given user's input observation data, the mechanisms identify the user's current lifecycle status. In the illustrative embodiments, a two-level Hidden Markov Model (HMM) model is utilized for lifecycle description and a HMM pair based approach is utilized for model training and learning. A Hidden Markov Model (HMM) is a statistical Markov model in which the system, user, or the like, being modeled is assumed to be a Markov process with unobserved (hidden) states. The mechanisms then personalize the user's E-commerce environment based on the detection of a user's current state(s) in the user's lifecycle.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present, To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of the examples provided herein without departing from the spirit and scope of the present invention.

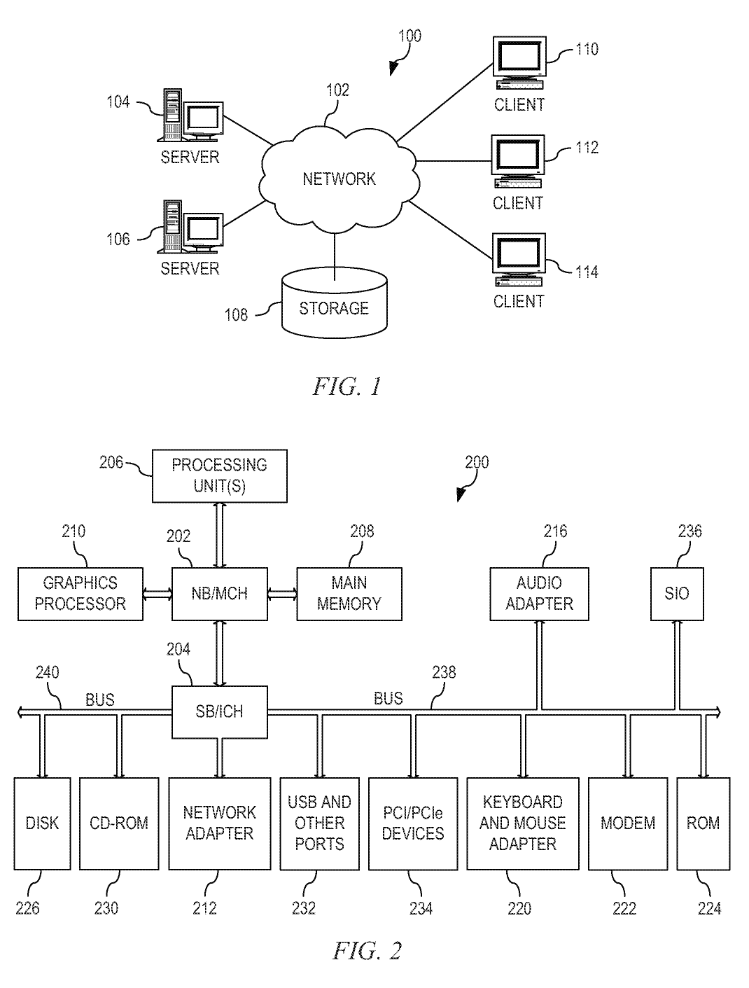

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data. processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot tiles, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 1110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204, Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while Nile does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

As stated previously, the illustrative embodiments provide mechanisms that model a user's lifecycle status based on the user's social media and transactional behavior. That is, a user may go through many stages in their lifetime, for example, elementary school, middle school, high school, college or university, graduate school, doctorate, job, wedding, marriage, pregnancy, children, home ownership, promotion, raising a baby, infant, or toddler, children entering school, military service, divorce, retirement, end-of life preparation, or the like, sonic or all of which may be identified in a user's social media. Furthermore, each cycle in the user's lifecycle may have strong indication in the user's shopping behavior. That is, for example, in a user's university life, the user may purchase small electronic products, such as a dorm refrigerator, small microwave, notebook, laptop, or the like, as well as dorm food, such as pizza, instant noodles, or the like. As another example, as a user is preparing for a wedding, the user may purchase wedding rings, announcements, wedding dress, tuxedo, or the like. As still a further example, if a user is redecorating their home, the user may purchase wallpaper, paint, tile, furniture, or the like. Therefore, combining transaction data with social media data, a lifecycle modeling mechanism may more quickly and definitively determined the user's lifecycle event. Whereas relying only on transactional history, even if used to judge lifecycle events, the event, such as a renovation, may have been judged to end once the materials have been bought, when in reality utilizing social media data it can be identified that the renovation is taking longer than the user intended even though no more material is being purchased and thus, recommendations may have stopped when such recommendations are most needed.

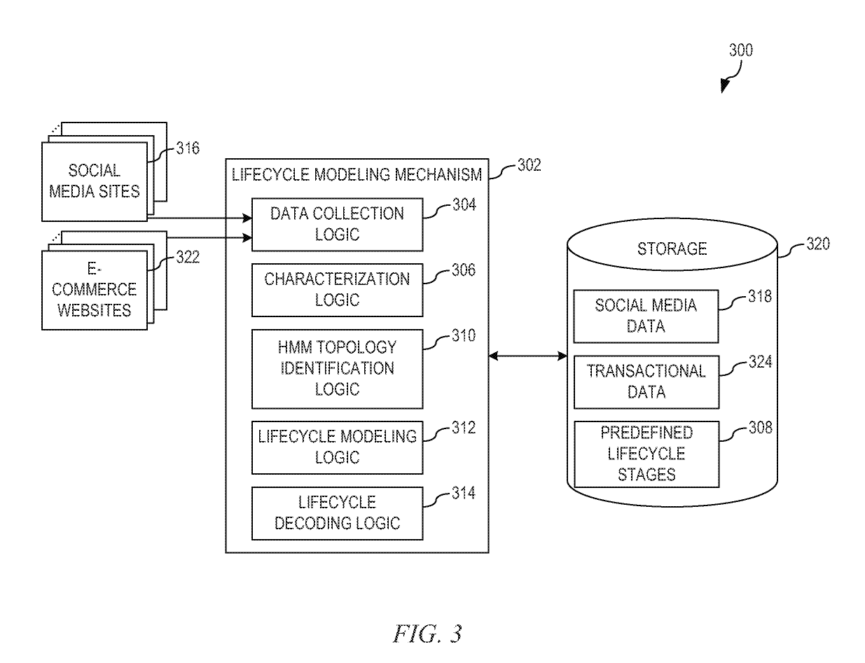

In one illustrative embodiment, such a user's lifecycle modeling mechanism for E-commerce may be implemented in a data processing system, such as client 110 in FIG. 1 or data processing system 200 of FIG. 2. FIG. 3 depicts one example of a lifecycle modeling mechanism operating within data processing system 300 in accordance with an illustrative embodiment. Lifecycle modeling mechanism 302 within data processing system 300 comprises data collection logic 304, characterization logic 306, Hidden Markov Model (HMM) topology identification logic 310, lifecycle modeling logic 312, and lifecycle decoding logic 314.

At the initialization of lifecycle modeling mechanism 302, data collection logic 304 collects training data that will be utilized to construct the lifecycle model of the user. Data collection logic 304 monitors the user's interactions with social media server sites 316, such as Twitter®, Facebook®, Instagram®, or the like, as well as transaction data with regard to purchases made via data processing system 300. From each social media site, data collection logic 304 may identify interaction with people and/or companies that are being followed, liked, posted to, chatted with, or the like, such as childcare, school district housing, colleges, subject experts, or the like. Data collection logic 304 may also identify interactions with forums, blogs, or the like. Data collection logic 304 stores the social media data 318 in storage 320. In addition to monitoring the user's interaction with social media, data collection logic 304 monitors the user's purchases, such as home improvement items, baby items, furniture, or the like, via one or more E-commerce server websites 322, such as Babies R Us®, Home Depot®, Amazon®, or the like. In addition to identifying transaction with websites, data collection logic 304 may also collect data with regard to the specific items being purchased, such as whether the diapers being purchased are preemie, newborn, size 1, size 2, size 3, size 4, size 5, or size 6; or whether the salty seat being purchases is for a baby or a toddler. Data collection logic 304 stores the transaction data 324 in storage 320.

Once data collection logic 304 has collected the social media data and the transaction data, characterization logic 306 analyzes the social media data and the transaction data for a given time period, such as the last week, last month, last three months, or the like, in order to identify one or more lifecycle stages that are being experienced by the user. That is, using a set of predefined lifecycle stages 308 in storage 320, such as elementary school, middle school, high school, college or university, graduate school, doctorate, job, wedding, marriage, pregnancy, children, home ownership, promotion, raising a baby, infant, or toddler, children entering school, military service, divorce, retirement, end-of life preparation, or the like, characterization logic 306 identifies one or more of the predefined lifecycle stages 308 that are being experienced. While the user may be experiencing multiple lifecycle stages at one time, characterization logic 306 analyzes the data in order to identify one or more important lifecycle stages. Therefore, for example, if the user has only one social media posting regarding pursuing a doctorate but has multiple social media. postings regarding wedding sites and wedding dresses as well as a transaction for a wedding dress, then characterization logic 306 identifies the lifecycle stage of wedding as having a higher importance than the importance of pursuing a doctorate. Thus, characterization logic 306 also identifies one or more important lifecycle stages, i.e. those ones of the one or more identified lifecycle stages that are above a predetermined threshold.

With the one or more important lifecycle stages identified, HMM topology identification logic 310 utilizes the identified one or more important lifecycle stages to generate a HMM topology comprising a set of level 1 lifecycle state transitions and a set of level 2 lifecycle state transitions. For example, if characterization logic 306 identities important lifecycle stages of wedding, college, and job, then HMM topology identification logic 310 may generate level 1 lifecycle state transitions of college job wedding. Then based on each of the level 1 lifecycle state transitions, HMM topology identification logic 310 may identify a set of level 2 lifecycle state transitions for each of the set of level 1 lifecycle state transitions. For example, with regard to job, HMM topology identification logic 310 may identify resume help, job search, interview assistance, travel arrangements, or the like. As another example, with regard to wedding, HMM topology identification logic 310 may identify wedding rings, announcements, wedding dress, tuxedo rental, or the like.

With the HMM topology identified, lifecycle modeling logic 312 then models the identified lifecycle state transitions by performing a lifecycle state transition probability calculation. That is, lifecycle modeling logic 312 maps the social media data and the transaction data collected by data collection logic 304 to one or more of the set of level 1 lifecycle state transitions or the set of level 2 lifecycle state transitions. The mapping of the social media data and the transaction data to one or more of the set of level 1 lifecycle state transitions or a set of level 2 lifecycle state transitions may be a one-to-one mapping, a one-to-many mapping, or the like. Furthermore, mapping of the social media data and the transaction data to one or more of the set of level 1 lifecycle state transitions or the set of level 2 lifecycle state transitions may include weighting each piece of collected data with a predefined weight. For example, job search may have a higher weight than résuméhelp or interview assistance and all three of those may have higher weights than travel arrangements. Thus, in mapping the social media data and the transaction data to one or more of the set of level 1 lifecycle state transitions or the set of level 2 lifecycle state transitions, lifecycle modeling logic 312 transfers the associated social media topic and transaction commodity as a predefined length of a vector to one or more of the set of level 1 lifecycle state transitions or the set of level 2 lifecycle state transitions.

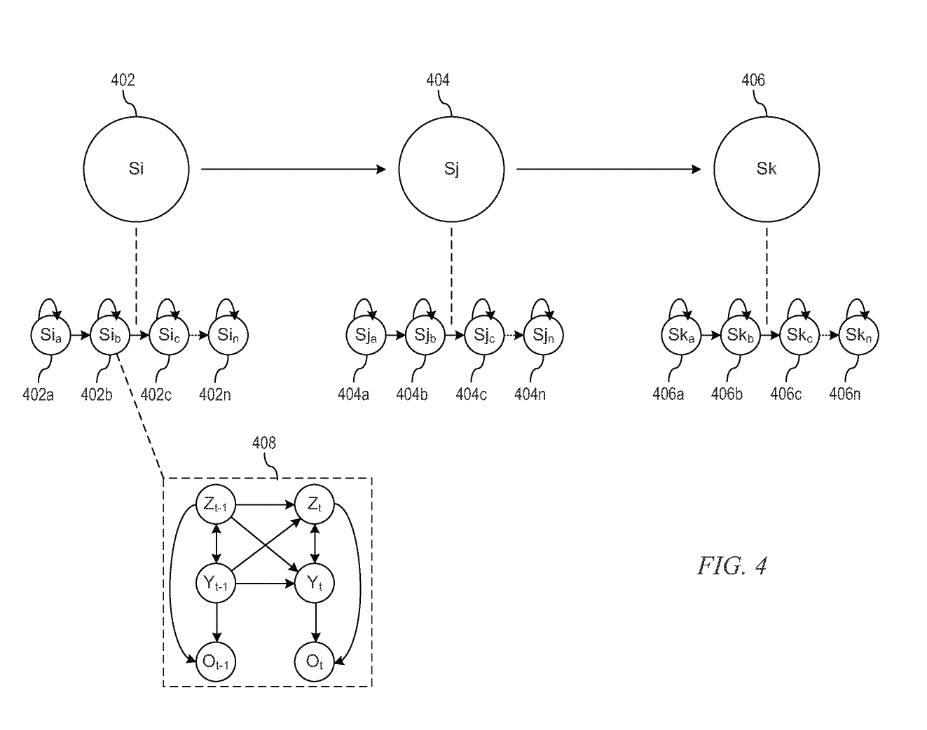

Utilizing the mapping, lifecycle modeling logic 312 generates a two-level HUM lifecycle model for the current lifecycle states being experienced by the user in order to achieve a fine grained product recommendation associated with the one or more important lifecycle stages and the identified lifecycle state transitions. FIG. 4 depicts an exemplary two-level HMM lifecycle model in accordance with an illustrative embodiment. As is illustrated, lifecycle modeling logic 312 models three level 1 lifecycle states Si 402→Sj 404→Sk 406. Additionally, for each level 1 lifecycle state, lifecycle modeling logic 312 models a set of level 2 lifecycle states: Siₐ402a, Si_{b}402b,Si_{c}402c, . . . , Siₙ402n; Sjₐ404a, Sj_{b}404b, Sj_{c}404c, . . . , Sjₙ404n; and Skₐ406a, Sk_{b}406b, Sk_{c}406c, Skₙ406n. However, in addition to identifying the level 2 lifecycle states, there may be instances where multiple lifecycle states overlap with each other. Therefore, when lifecycle modeling logic 312 identifies the two or more lifecycle states that overlap with each other, lifecycle modeling logic 312 models the lifecycle state overlaps. For example, lifecycle state Si_{b}402b may have many sub-states that form HMM pair 408. As is illustrated, there are three sub-states Z, Y, and O and a times t-1 and t, each state transitions from Zₜ→Zₜ and Yᵢ₋₁→Yₜ. However, as is also illustrated, other state transitions occur, such as: Zₜ₁→Yₜ₋₁; Yₜ₋₁→Zₜ₋₁; Zₜ₋₁→Oₜ₋₁; Yₜ₋₁→Oₜ₋₁; Zₜ₋₁→Yₜ; Yₜ₋₁→Zₜ; Zₜ→Yₜ; Yₜ; Yₜ→Zₜ; Zₜ→Oₜ; and Yₜ→Oₜ. By modeling the multiple lifecycle state transitions as is illustrate in HMM pair 408, lifecycle modeling logic 312 makes full use of mixing information from multiple sequences and thereby avoids inaccuracy of prediction of the lifecycle state sequences caused by data sparseness and also solves the modeling under multiple lifecycle states that coincide at the same time.

With the two-level HMM lifecycle model, lifecycle decoding logic 314 utilizes the two-level HMM lifecycle model to generate one or more future behavioral predictions with regard to the user's lifecycle. Additionally, using the one or more future behavioral predictions, lifecycle decoding logic 314 may issue one or more recommendations to the user, such as posting advertisements for products, applications, or the like; issuing coupons for certain products that the user will be likely to buy; provide finks to video sites that may assist the user; or the like.

In order to provide real world examples of how the operation performed by lifecycle modeling mechanism 302 may operate, consider, for example, the following. Suppose a user posts a picture of a piece of hail being held in their hand on a social media site, a “like” to a home insurance company, and then a purchase of plywood from an home improvement website in the hours or day that follows. Lifecycle modeling mechanism 302 would be able to analyze both of those pieces of data and provide one or more recommendations, such as auto dent repair, a roofing contractor, storm damage repair company, and an emergency contact number for the home insurance company. As another example, suppose a user posts a picture of a leaking kitchen sink with a purchase of a new kitchen faucet from Amazon®. Lifecycle modeling mechanism 302 would be able to analyze both of those pieces of data and provide one or more recommendations, such as a video link on how the user can replace the faucet, an advertisement for a local plumber, and a coupon for an in-line water filter.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

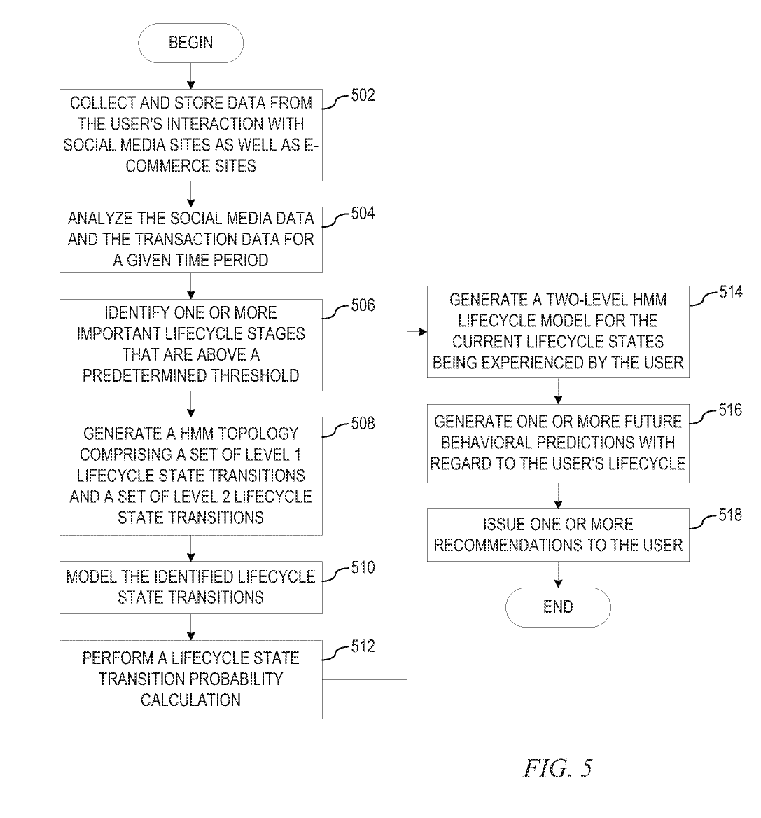

FIG. 5 depicts an exemplary flowchart of the operation performed by a lifecycle modeling mechanism in personalizing a user's E-commerce environment based on a detection of the user's current state(s) in the user's lifecycle. As the operation begins, the lifecycle modeling mechanism collects and stores data from the user's interaction with social media sites as well as E-commerce sites (step 502). In collecting data from the social media sites, the lifecycle modeling mechanism monitors social media sites such as Twitter®, Facebook®, Instagram®, or the like, From each social media site, the lifecycle modeling mechanism may identify interaction with people and/or companies that are being followed, liked, posted to, chatted with, or the like, such as childcare, school district housing, colleges, subject experts, or the like, as well as forums, blogs, or the like. In collecting data from the E-commerce sites, the lifecycle modeling mechanism monitors E-commerce sites, such as Babies R Us®, Home Depot®, Amazon®, or the like.

With the collected social media data and the transaction data, the lifecycle modeling mechanism analyzes the social media data and the transaction data for a given time period, such as the last week, last month, last three months, or the like (step 504), in order to identify one or more lifecycle stages that are being experienced by the user. That is, using a set of predefined lifecycle stages, such as elementary school, middle school, high school, college or university, graduate school, doctorate, job, wedding, marriage, pregnancy, children, home ownership, promotion, raising a baby, infant, or toddler, children entering school, military service, divorce, retirement, end-of life preparation, or the like, the lifecycle modeling mechanism identifies one or more of the predefined lifecycle stages that are being experienced. Based on the identified lifecycle stages, the lifecycle modeling mechanism identifies one or more important lifecycle stages that are above a predetermined threshold (step 506).

With the one or more important lifecycle stages identified, the lifecycle modeling mechanism utilizes the identified one or more important lifecycle stages to generate a topology comprising a set of level 1 lifecycle state transitions and a set of level 2 lifecycle state transitions (step 508). Once the HMM topology is identified, the lifecycle modeling mechanism models the identified lifecycle state transitions (step 510) and performs a lifecycle state transition probability calculation (step 512). That is, the lifecycle modeling mechanism maps the collected social media data and the transaction data to one or more of the set of level 1 lifecycle state transitions or the set of level 2 lifecycle state transitions. The mapping of the social media data and the transaction data to one or more of the set of level 1 lifecycle state transitions or a set of level 2 lifecycle state transitions may be a one-to-one mapping, a one-to-many mapping, or the like. Furthermore, mapping of the social media data and the transaction data to one or more of the set of level 1 lifecycle state transitions or the set of level 2 lifecycle state transitions may include weighting each piece of collected data with a predefined weight. Thus, in mapping the social media data and the transaction data to one or more of the set of level 1 lifecycle state transitions or the set of level 2 lifecycle state transitions, lifecycle modeling logic transfers the associated social media topic and transaction commodity as a predefined length of a vector to one or more of the set of level 1 lifecycle state transitions or the set of level 2 lifecycle state transitions.

Utilizing the mapping, the lifecycle modeling mechanism generates a two-level HMM lifecycle model for the current lifecycle states being experienced by the user in order to achieve a fine grained product recommendation associated with the one or more important lifecycle stages and the identified lifecycle state transitions (step 514). With the two-level HMM lifecycle model, the lifecycle modeling mechanism utilizes the two-level lifecycle model to generate one or more future behavioral predictions with regard to the user's lifecycle (step 516). Additionally, using the one or more future behavioral predictions, the lifecycle modeling mechanism issues one or more recommendations to the user, such as posting advertisements for products, applications, or the like; issuing coupons for certain products that the user will be likely to buy; provide links to video sites that may assist the user; or the like (step 518), with the operation terminating thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for user lifecycle status modeling based on user's social media and shopping behavior in order to personalize the user's E-commerce environment based on user's lifecycle detection. The mechanisms collect social media and transaction data to construct the lifecycle model, which describes the transmission probability between the user's status, as well as the probability of observation generation. Given user's input observation data, the mechanisms identify the user's current lifecycle status using a two-level Hidden Markov Model (HMM) model and, possible, one or more HMM pairs. The mechanisms then personalize the user's E-commerce environment based on the detection of a user's current state(s) in the user's lifecycle.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations wilt be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for personalizing a user's E-commerce environment, the method comprising:
modeling identified lifecycle state transactions associated with the user by performing a lifecycle state transition probability calculation utilizing collected social media data and transaction data;
utilizing the model of the identified lifecycle state transactions, generating a two-level Hidden Markov Model (HMM) lifecycle model for current lifecycle states being experienced by the user;
utilizing the two-level HMM lifecycle model for current lifecycle states being experienced by the user, generating one or more future behavioral predictions with regard to the user's lifecycle; and
issuing one or more E-commerce recommendations to the user based on the one or more future behavioral predictions.

2. The method of claim 1, wherein the social media data and the transaction data are collected from at least one of a social media server or an E-commerce server via a network.

3. The method of claim 1, wherein the identified lifecycle state transactions are identified by the method comprising:
analyzing collected social media data and transaction data for a given time period ending with a current time in order to identify one or more lifecycle stages that are being experienced by the user;
identifying one or more important lifecycle stages that are above a predetermined threshold; and
generating a Hidden Markov Model (HMM) topology comprising a set of level 1 lifecycle state transitions and a set of level 2 lifecycle state transitions.

4. The method of claim 3, wherein generating the two-level HMM lifecycle model for the current lifecycle states being experienced by the user comprises:
mapping the collected social media data and the transaction data to one or more of the set of level 1 lifecycle state transitions or the set of level 2 lifecycle state transitions.

5. The method of claim 4, wherein the mapping is at least one of a one-to-one mapping or a one-to-many mapping.

6. The method of claim 4, wherein the mapping further comprises:
weighting each piece of the collected social media data or transaction data according to a predefined importance associated with the particular collected social media data or transaction data.

7. The method of claim 3, wherein the two-level HMM lifecycle model for the current lifecycle states being experienced by the user further comprises at least one HMM pair and wherein the HMM pair comprises multiple lifecycle state transitions within a given state and makes full use of mixing information from multiple sequences thereby avoiding inaccuracy of prediction of lifecycle state sequences caused by data sparseness and solving modeling under multiple lifecycle states that coincide at a same time.

8. The method of claim 1, wherein the one or more E-commerce recommendations are at least one of an advertisement for a product, an advertisement for an application, a coupon for a product, a link to a video to assist the user, a recommendation of a company or a professional to assist the user, or an emergency contact number.

9. A computer program product comprising a computer readable storage medium having a computer readable program stored therein, wherein the computer readable program, when executed on a computing device, causes the computing device to:
model identified lifecycle state transactions associated with the user by performing a lifecycle state transition probability calculation utilizing collected social media data and transaction data;
utilizing the model of the identified lifecycle state transactions, generate a two-level Hidden Markov Model (HMM) lifecycle model for current lifecycle states being experienced by the user;
utilizing the two-level HMM lifecycle model for current lifecycle states being experienced by the user, generate one or more future behavioral predictions with regard to the user's lifecycle; and
issue one or more E-commerce recommendations to the user based on the one or more future behavioral predictions.

10. The computer program product of claim 9, wherein the social media data and the transaction data are collected from at least one of a social media server or an E-commerce server via a network.

11. The computer program product of claim 9, wherein the identified lifecycle state transactions are identified by the computer readable program further causing the computing device to:
analyze collected social media data and transaction data for a given time period ending with a current time in order to identify one or more lifecycle stages that are being experienced by the user;
identify one or more important lifecycle stages that are above a predetermined threshold; and
generate a Hidden Markov Model (HMM) topology comprising a set of level state transitions and a set of level 2 lifecycle state transitions.

12. The computer program product of claim 11, wherein the computer readable program to generate the two-level lifecycle model for the current lifecycle states being experienced by the user further causes the computing device to:
map the collected social media data and the transaction data to one or more of the set of level 1 lifecycle state transitions or the set of level 2 lifecycle state transitions, wherein the mapping is at least one of a one-to-one mapping or a one-to-many mapping and wherein the computer readable program to map the collected social media data and the transaction data to one or more of the set of level 1 lifecycle state transitions or the set of level 2 lifecycle state transitions further causes the computing device to:
weight each piece of the collected social media data or transaction data according to a predefined importance associated with the particular collected social media data or transaction data.

13. The computer program product of claim 11, wherein the two-level HMM lifecycle model for the current lifecycle states being experienced by the user further comprises at least one HMM pair and wherein the pair comprises multiple lifecycle state transitions within a given state and makes full use of mixing information from multiple sequences thereby avoiding inaccuracy of prediction of lifecycle state sequences caused by data sparseness and solving modeling under multiple lifecycle states that coincide at a same time.

14. The computer program product of claim 9, wherein the one or more E-commerce recommendations are at least one of an advertisement for a product, an advertisement for an application, a coupon for a product, a link to a video to assist the user, a recommendation of a company or a professional to assist the user, or an emergency contact number.

15. An apparatus comprising:
a processor; and
a memory coupled to the processor, wherein the memory comprises instructions which, when executed by the processor, cause the processor to:
model identified lifecycle state transactions associated with the user by performing a lifecycle state transition probability calculation utilizing collected social media data and transaction data;
utilizing the model of the identified lifecycle state transactions, generate a two-level Hidden Markov Model (HMM) lifecycle model for current lifecycle states being experienced by the user;
utilizing the two-level HMM lifecycle model for current lifecycle states being experienced by the user, generate one or more future behavioral predictions with regard to the user's lifecycle; and
issue one or more E-commerce recommendations to the user based on the one or more future behavioral predictions.

16. The apparatus of claim 15, wherein the social media data and the transaction data are collected from at least one of a social media. server or an E-commerce server via a network.

17. The apparatus of claim 15, wherein the identified lifecycle state transactions are identified by the instructions further causing the processor to:
analyze collected social media data and transaction data for a given time period ending with a current time in order to identify one or more lifecycle stages that are being experienced by the user;
identify one or more important lifecycle stages that are above a predetermined threshold; and
generate a Hidden Markov Model (HMM) topology comprising a set of level state transitions and a set of level 2 lifecycle state transitions.

18. The apparatus of claim 17, wherein the instructions to generate the two-level HMM lifecycle model for the current lifecycle states being experienced by the user further cause the processor to:
map the collected social media data and the transaction data to one or more of the set of level 1 lifecycle state transitions or the set of level 2 lifecycle state transitions, wherein the mapping is at least one of a one-to-one mapping or a one-to-many mapping and wherein the instructions to map the collected social media data and the transaction data to one or more of the set of level 1 lifecycle state transitions or the set of level 2 lifecycle state transitions further cause the processor to:
weight each piece of the collected social media data or transaction data according to a predefined importance associated with the particular collected social media data or transaction data.

19. The apparatus of claim 17, wherein the two-level HMM lifecycle model for the current lifecycle states being experienced by the user further comprises at least one HMM pair and wherein the HMM pair comprises multiple lifecycle state transitions within a given state and makes full use of mixing information from multiple sequences thereby avoiding inaccuracy of prediction of lifecycle state sequences caused by data sparseness and solving modeling under multiple lifecycle states that coincide at a same time.

20. The apparatus of claim 15, wherein the one or more E-commerce recommendations are at least one of an advertisement for a product, an advertisement for an application, a coupon for a product, a link to a video to assist the user, a recommendation of a company or a professional to assist the user, or an emergency contact number.
